(19) United States
(12) Patent Application Publication
(10) Pub. No.: US 2023/0301312 A1
(43) Pub. Date: Sep. 28, 2023

(54) EVEN SPEED DEVICE AND FOOD FORMING APPARATUS THEREOF

(71) Applicant: ANKO FOOD MACHINE CO., LTD., New Taipei City (TW)

(72) Inventors: Kai Hsiang Wang, New Taipei City (TW); Po Hsiang Wang, New Taipei City (TW)

(21) Appl. No.: 17/857,004

(22) Filed: Jul. 3, 2022

(30) Foreign Application Priority Data
Mar. 22, 2022 (TW) 111202833

(51) Int. Cl. A21C 9/00; A21C 11/22

(52) U.S. Cl. CPC A21C 9/00; A21C 11/22

(57) ABSTRACT

Provided is a food forming apparatus. An even speed device with a plurality of penetrating holes is disposed before the dough passes through the food shaping mold, making the dough to have even speed in the forming area (usually be cylindrical but not limited), then the food formed by passing through the food shaping mold Will have more consistent length and eliminate the technical issue about the inconsistent lengths of the food.

### FIELD OF THE INVENTION

The present invention relates to an even speed device and a food forming apparatus thereof, and more particularly relates to an application employed for food processing machinery to solve the technical issue about the inconsistent lengths of the foods caused by the uneven speed of the dough.

### BACKGROUND OF THE INVENTION

Please refer to FIG. 1, which depicts an exploded diagram of a forming area of a food forming apparatus 10 in the prior art. It comprises a food shaping mold 11 disposed at the outlet end to determine the sectional shape of the dough. When the dough is pushed from the left to the right by a screw, a piston or other means, the speed of the dough in the direction parallel to the food shaping mold 11 is not even due to friction, vacuum and many other factors, so that the length of the food after the dough passes through the food shaping mold 11 is inconsistent.

Thus, there is a need to provide an even speed device and a food forming apparatus thereof to solve the foregoing technical issue of the prior art.

### SUMMARY OF THE INVENTION

In order to solve the foregoing technical issue of the prior art, the present invention disposed an even speed device with a plurality of penetrating holes before the dough passes through the food shaping mold, making the dough to have even speed in the forming area (usually cylindrical but not limited), then the food formed by passing through the food shaping mold will have more consistent length and eliminate the technical issue about the inconsistent lengths of the food.

An objective of the present invention provides an even speed device for a food forming apparatus, comprising a plate body, and the plate body comprises a plurality of penetrating holes for allowing dough to move from a first side to a second side of the plate body through the plurality of penetrating holes.

In a preferred embodiment, a hole wail of each of the plurality of penetrating holes possesses an angle, and the angle is between 0 degree and 70 degrees.

In a preferred embodiment, the angle is adjusted according to a penetrating speed of the dough at a location of each of the penetrating holes.

In a preferred embodiment, arrangement of the plurality of penetrating holes at respective locations on the plate body is adjusted according to a penetrating speed of the dough at a location of each of the penetrating holes.

In a preferred embodiment, the plate body comprises a shaft hole in the center,

In a preferred embodiment, cross-sectional areas of the plurality of penetrating holes on the first side are larger than cross-sectional areas of the plurality of penetrating holes on the second side.

In a preferred embodiment, cross-sectional areas of the plurality of penetrating holes on the second side are all equal.

In order to solve the problem of the aforesaid prior art, another objective of the present invention further provides a food forming apparatus, comprising a feeding area, a conveying area and a forming area. The feeding area is employed to feed dough. The conveying area is connected to the feeding area to convey the dough. The forming area is connected to the conveying area and comprises an even speed device and a food shaping mold. The dough is pushed to pass through the even speed device and the food shaping mold in sequence. The even speed device comprises a plate body, and the plate body comprises a plurality of penetrating holes for allowing the dough to move from a first side to a second side of the plate body through the plurality of penetrating holes.

In a preferred embodiment, a hole wall of each of the plurality of penetrating holes possesses an angle, and the angle is between 0 degree and 70 degrees.

In a preferred embodiment, the angle is adjusted according to a penetrating speed of the dough at a location of each of the penetrating holes.

In a preferred embodiment, arrangement of the plurality of penetrating holes at respective locations on the plate body is adjusted according to a penetrating speed of the dough at a location of each of the penetrating holes.

In a preferred embodiment, the plate body comprises a shaft hole in the center.

In a preferred embodiment, cross-sectional areas of the plurality of penetrating holes on the first side are larger than cross-sectional areas of the plurality of penetrating holes on the second side.

In a preferred embodiment, cross-sectional areas of the plurality of penetrating holes on the second side are all equal.

In a preferred embodiment, the even speed device and the food shaping mold are arranged in close contact with each other.

In a preferred embodiment, the even speed device and the food shaping mold are integrally formed.

Compared with the prior art, since the present invention disposed an even speed device with a plurality of penetrating holes before the dough passes through the food shaping mold, it makes the dough to have even speed in the forming area (usually cylindrical but not limited), then the food formed by passing through the food shaping mold will have more consistent length and eliminate the technical issue about the inconsistent lengths of the food.

### BRIEF DESCRIPTION OF THE DRAWINGS

FIG. 1 depicts an exploded diagram of a forming area of a food forming apparatus 10 in the prior art;

FIG. 2 depicts a diagram of an entire machine comprising a food forming apparatus according to the present invention;

FIG. 3 depicts an exploded perspective diagram of a forming area of the present invention according to FIG. 1;

FIG. 4 depicts an exploded side view diagram of the forming area of the present invention according to FIG. 1;

FIG. 5 depicts a diagram of the left and right sides of an even speed device of the present invention according to FIG. 1;

FIG. 6 depicts a cross-sectional diagram of the even speed device and the food shaping mold according to another preferred embodiment of the present invention;

FIG. 7 depicts a diagram of the left and right sides of another even speed device according to the present invention; and

FIG. 8 depicts a cross-sectional diagram of another even speed device according to the present invention.

### DETAILED DESCRIPTION OF PREFERRED EMBODIMENTS

The following descriptions of the embodiments refer to the appended figures to illustrate specific embodiments in which the present invention may be implemented. The directional terms of up, down, front, rear, left, right, interior, exterior, side, etcetera mentioned in the present invention are merely directions of referring to appended figures. Therefore, the aforesaid directional terms are employed for explaining and understanding the present invention, but the present invention is not limited thereto.

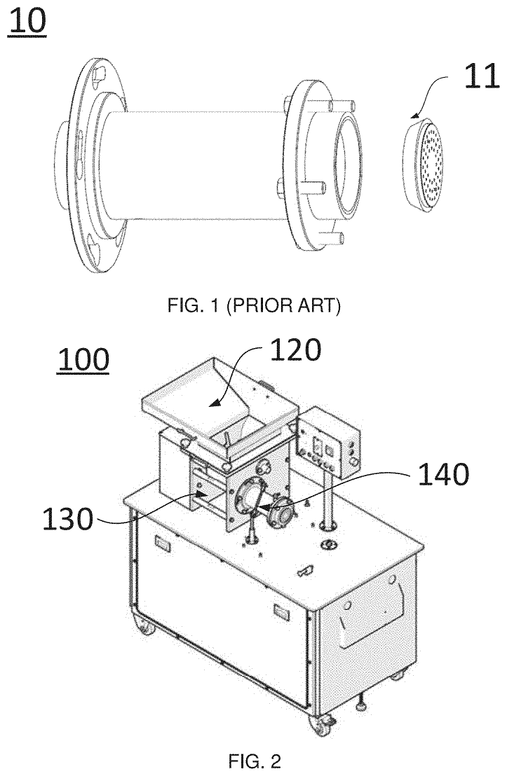

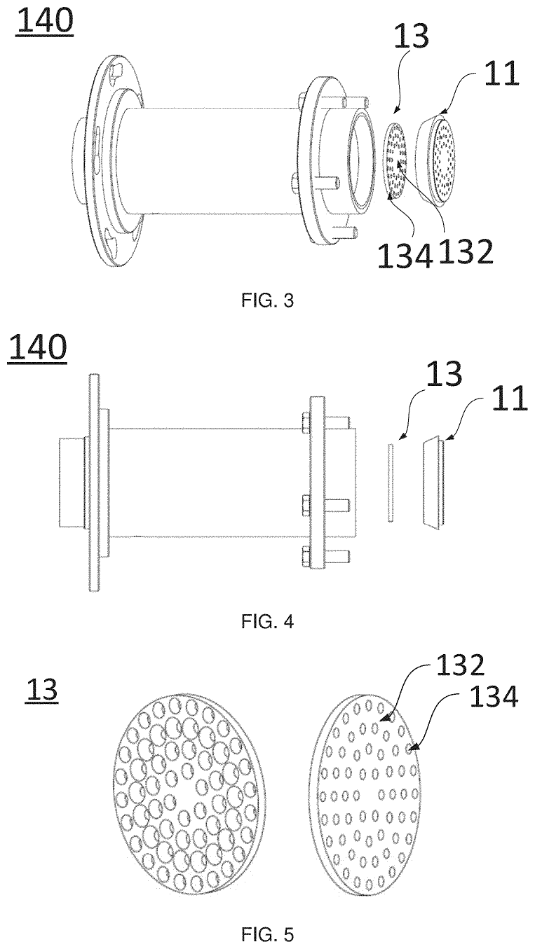

Referring to FIGS. 2-5, FIG, 2 depicts a diagram of an entire machine comprising a food forming apparatus 100 according to the present invention; FIG. 3 depicts an exploded perspective diagram of a forming area 140 of the present invention according to FIG. 1; FIG. 4 depicts an exploded side view diagram of the forming area 140 of the present invention according to FIG. 1; FIG. 5 depicts a diagram of the left and right sides of an even speed device 13 of the present invention according to FIG. 1, The food forming apparatus 100 comprises a feeding area 120, a conveying area 130 and a forming area 140. The feeding area 120 is employed to feed dough (not shown). In this preferred embodiment, only dough is employed as an illustration, so the resulting product is noodles. However, as long as the food material possesses the similar physical properties (with similar technical issue of uneven speed), such as noodles, biscuits, candy, pet snack bars, teeth cleaning bones, etc., all of them can be the objects that the present invention intends to protect. The conveying area 130 is connected to the feeding area 120 to convey the dough. In detail, the dough may also be mixed and stirred again at this place, and it is not limited to be used only for conveying the dough. Mostly, the forming area 140 is connected to the conveying area 130 and comprises an even speed device 13 and a food shaping mold 11. The dough is pushed to pass through the even speed device 13 and the food shaping mold 11 in sequence. The even speed device 13 comprises a plate body 132, and the plate body 132 comprises a plurality of penetrating holes 134 for allowing the dough to move from a first side to a second side of the plate body 132 through the plurality of penetrating holes 134. In this preferred embodiment, the plate body 132 is in a shape of a disc, that is, the corresponding forming area is a cylinder as shown in FIG. 3. As shown in FIG. 3, the first side is the part closer to the conveying area 130, and the second side is the part closer to the food shaping mold 11. As shown in FIG. 5, a hole wall of each of the plurality of penetrating holes 134 is a cone having no tip. Preferably, a hole wall of each of the plurality of penetrating holes 134 possesses an angle, and the angle is between 0 degree and 70 degrees. Preferably, when the angle is between 0 degree and 60 degrees, it possesses better effect on the dough of certain properties, However, according to the applicant's experiments, under certain circumstances, even if the wall surfaces of the plurality of penetrating holes 134 do not possess an angle, an even speed effect can be produced to a certain extent, which is not limited to the figures.

Preferably, the angle is adjusted according to a penetrating speed of the dough at a location of each of the penetrating holes 134. For instance, as the plate body 132 is illustrated, when the speed of the dough in a specific area is faster, the angles of the walls of the plurality of penetrating holes 134 near the specific area can be adjusted to be small and/or the number of the plurality of penetrating holes 134 near the specific area can be adjusted.

Preferably, as the aforesaid angles that can be employed to adjust the speed of the dough, the arrangement of the plurality of penetrating holes 134 at respective locations (various locations) on the plate body 132 also can be adjusted according to the penetrating speed of the dough at the location of each of the penetrating holes 134.

In other words, in the present invention, the angles of the penetrating holes and the arrangements in different locations are further adjusted to deal with different dough properties by the arrangement of the penetrating holes.

Preferably, as shown in FIG. 3, the even speed device 13 and the food shaping mold 11 are arranged in close contact with each other in this preferred embodiment. Because once the distance between the two is too large, the dough will be squeezed into a ball again, and the effect of even speed will be eliminated.

In detail, referring to FIG. 5, cross-sectional areas of the plurality of penetrating holes 134 on the first side are larger than cross-sectional areas of the plurality of penetrating holes 134 on the second side. The effect thereof is to equalize the speed of the dough in the direction perpendicular to the plate body 132 within a certain range, thus making the lengths of the dough (food) that finally passes through the food shaping mold 11 be consistent and equal.

Preferably, the cross-sectional areas of the plurality of penetrating holes 134 on the second side are all equal.

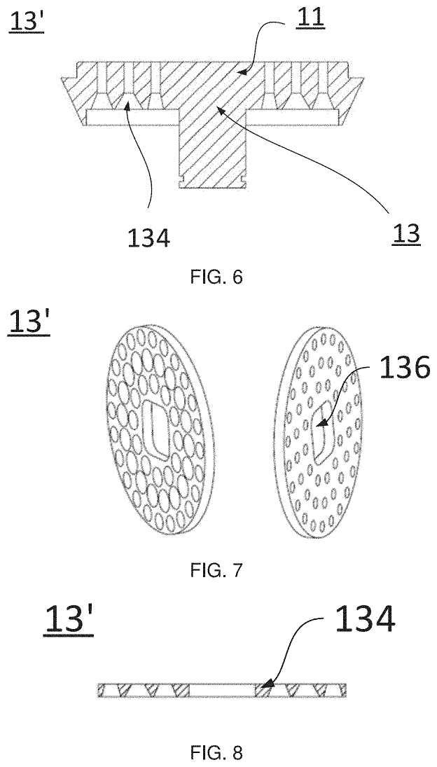

Please refer to FIG. 6, which depicts a cross-sectional diagram of the even speed device 13′ and the food shaping mold 11 according to another preferred embodiment of the present invention, It can be seen that the plurality of penetrating holes 134 of the even speed device 13′ are directly connected to the forming holes (not shown) of the food shaping mold 11. Preferably, since there should be no gap between the even speed device 13 and the food shaping mold 11, the integral formation can further reduce the difficulty of assembly.

FIG. 7 depicts a diagram of the left and right sides of another even speed device 13″ according to the present invention. The difference between this preferred embodiment and the first preferred embodiment is: the plate body 132 comprises a shaft hole 136 in the center. Different from the first preferred embodiment, this preferred embodiment can correspond to a food forming apparatus with a shaft in the center (generally, a rotating shaft as used in a stirring or mixing device as aforementioned), and can also adopt the shaftless hole design as in the first preferred embodiment.

FIG. 8 depicts a cross-sectional diagram of another even speed device according to the present invention. As clearly shown in figure, the side structure of the plurality of penetrating holes 134 is a trapezoid, thereby resulting in that the lengths of the dough that finally passes through the food shaping mold 11 are consistent and equal.

Above are only preferred embodiments of the present invention, and it should be noted that to any persons who are skilled in the art, improvement and modification which is easily derived should be covered by the protected scope of the application. Thus, the protected scope of the application should go by the subject claims, including the improvement and the modification.

### Element Number Description

10, 100 food forming apparatus
11 food shaping mold
13, 13′ even speed device
120 feeding area
130 conveying area
132 plate body
134 penetrating hole
136 shaft hole
140 forming area

What is claimed is:

1. An even speed device for a food forming apparatus, comprising:
a plate body, comprising a plurality of penetrating holes for allowing dough to move from a first side to a second side of the plate body through the plurality of penetrating holes.

2. The even speed device according to claim 1, wherein a hole wall of each of the plurality of penetrating holes possesses an angle, and the angle is between 0 degree and 70 degrees.

3. The even speed device according to claim 2, wherein the angle is adjusted according to a penetrating speed of the dough at a location of each of the penetrating holes.

4. The even speed device according to claim 1, wherein arrangement of the plurality of penetrating holes at respective locations on the plate body is adjusted according to a penetrating speed of the dough at a location of each of the penetrating holes.

5. The even speed device according to claim 2, wherein arrangement of the plurality of penetrating holes at respective locations on the plate body is adjusted according to a penetrating speed of the dough at a location of each of the penetrating holes.

6. The even speed device according to claim 3, wherein arrangement of the plurality of penetrating holes at respective locations on the plate body is adjusted according to a penetrating speed of the dough at a location of each of the penetrating holes.

7. The even speed device according to claim 1, wherein the plate body comprises a shaft hole in the center.

8. The even speed device according to claim 1, wherein cross-sectional areas of the plurality of penetrating holes on the first side are larger than cross-sectional areas of the plurality of penetrating holes on the second side.

9. The even speed device according to claim 1, wherein cross-sectional areas of the plurality of penetrating holes on the second side are all equal.

10. A food forming apparatus, comprising:
a feeding area, employed to feed dough;
a conveying area, connected to the feeding area to convey the dough; and
a forming area, connected to the conveying area, comprising an even speed device and a food shaping mold, wherein the dough is pushed to pass through the even speed device and the food shaping mold in sequence;
wherein the even speed device comprises a plate body, and the plate body comprises a plurality of penetrating holes for allowing the dough to move from a first side to a second side of the plate body through the plurality of penetrating holes.

11. The food forming apparatus according to claim 10, wherein a hole wall of each of the plurality of penetrating holes possesses an angle, and the angle is between 0 degree and 70 degrees.

12. The food forming apparatus according to claim 11, wherein the angle is adjusted according to a penetrating speed of the dough at a location of each of the penetrating holes.

13. The food forming apparatus according to claim 10, wherein arrangement of the plurality of penetrating holes at respective locations on the plate body is adjusted according to a penetrating speed of the dough at a location of each of the penetrating holes.

14. The food forming apparatus according to claim 11, wherein arrangement of the plurality of penetrating holes at respective locations on the plate body is adjusted according to a penetrating speed of the dough at a location of each of the penetrating holes.

15. The food forming apparatus according to claim 12, wherein arrangement of the plurality of penetrating holes at respective locations on the plate body is adjusted according to a penetrating speed of the dough at a location of each of the penetrating holes.

16. The food forming apparatus according to claim 10, wherein the plate body comprises a shaft hole in the center.

17. The food forming apparatus according to claim 10, wherein cross-sectional areas of the plurality of penetrating holes on the first side are larger than cross-sectional areas of the plurality of penetrating holes on the second side.

18. The food forming apparatus according to claim 10, wherein cross-sectional areas of the plurality of penetrating holes on the second side are all equal.

19. The food forming apparatus according to claim 10, wherein the even speed device and the food shaping mold are arranged in close contact with each other.

20. The food forming apparatus according to claim 10, wherein the even speed device and the food shaping mold are integrally formed.
